(19) United States
(12) Patent Application Publication
(10) Pub. No.: US 2006/0294069 A1
(43) Pub. Date: Dec. 28, 2006

(54) Sorting and filtering in an interactive report

(75) Inventors: Jason D. Carlson, Redmond, WA (US); Christopher A. Hays, Monroe, WA (US); Fang Wang, Redmond, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/167,780

(22) Filed: Jun. 27, 2005

(51) Int. Cl. G06F 17/30

(52) U.S. Cl. 707/3

(57) ABSTRACT

End user sorting and filtering of data extracted for report processing can be performed. That is, data can be filtered or sorted subsequent to the execution of underlying queries performed to extract data from a data source. A user can sort or filter data by selecting a set of data values using a filter or sort control attached to a header or to a data field. The scope of effect of the filter or sort within the report may be specified. That is, a specified filter or sort may act locally or may apply globally. Filtering or sorting may apply to other regions of data linked to the filtered or sorted data region according to the specified scope of the filter. A filter or sort may apply to each row of data in the data set, to each row of data in the data region, to each instance of a group or to one or more sets of data.

### BACKGROUND

Computerized report generation is widely used today, especially in the business arena, to help people understand, for example, the performance of a business organization, to enable them to act on the most recent information available, and so on. The ability to produce reports is a critical tool for corporate performance management and therefore understandably comprises an important component of the business intelligence (BI) market. Computerized reporting solutions enable users to extract data, analyze the extracted data, and assemble reports based on the analyzed data. A number of reporting solutions are available including those offered by companies such as Cognos, Business Objects, Microstrategy, and others.

Computerized reporting in general can be described as follows: given a relational database or any other data source, users want to be able to take the data, or portions thereof, perform computations on it, and display it to the user in some specified format. Some such formats are interactive in nature, meaning that the user can, for example, click on a link that will take her to other data, or click on a link that will cause the data to become sorted and so on. Typically, however, sorting and filtering after the data extraction phase of report generation, if available at all, is very limited. For example, in a traditional interactive report layout, a table of data may contain headers, such as country, customer name and state and may associate the headers with columns of data from a database. Suppose a customer database contains the following data:

| Country | Name | State |
|---|---|---|
| USA | Joe | PA |
| USA | Peter | CA |
| USA | John | WA |

A user may be able to mark a particular column header to indicate that the data is to be sorted on that column. For example, selecting the name header may cause the report to list the data in alphabetical order by name.

In Microsoft's EXCEL, an auto sorting and auto filtering facility is provided that identifies sortable items at the top of each column by a visual control that, when clicked on, provides the user the ability to sort all of the data in the report by that column. However, in EXCEL, as in other known reporting systems, only those items visible in the report interface are available for sorting. Other limitations with known reporting systems include the following: without specifically programming a particular report to do so, a user is unable to select a single sort that affects both a table and a chart derived from the same data, or if a single sort does affect both the table and the chart, any change to the data in the table (not just the specific sort or filter operation) is always reflected in the chart; group level sorting on aggregates is not available, and intra-group sorting is not available.

Furthermore, some query languages do not support filtering of a target data source, or provide only limited filtering capabilities. For example, traditional reporting solutions provide filtering only as part of query processing, (that is, filtering is performed during the data extraction phase of the report processing, before the report-viewing phase). The inventors are unaware of any product that enables parameterized (parameter-based) filtering and sorting that is performed after data extraction, during the report-viewing phase. It would be helpful if more flexible sorting and filtering options were available within a general reporting system without requiring custom programming.

### SUMMARY

End user sorting and filtering of data extracted for report processing can be performed. That is, data can be filtered subsequent to the execution of underlying queries performed to extract data from a data source instead of being performed during the data extraction phase of report processing. Parameter-based filtering after the data extraction phase enables the display of different segments of the underlying data in different data regions to be handled via a single query using different filters on the various data regions. A user can filter data by selecting a set of data values using a filter control attached to a header or to a data field. The scope of effect of the filter within the report may be specified. That is, a specified filter may act locally (to a data grouping within the report) or may apply globally (to wherever the filtered data appears within the whole report). Filtering may apply to other regions of data within the report linked to the filtered data region according to the specified scope of the filter. A filter may apply to each row of data in the data set, to each row of data in the data region, or to each instance of a group. Multiple filters may be applied to a data set, data region or group. Multiple filters are applied in order. A filter applied in one report may automatically be applied to other sets of data.

Sorting of the report data is available at a detail, group, data region or data set level after the data extraction phase has been performed. The effect of the sort within the report may be specified. The effect of the sort specified in one data region within the report may be propagated to other data regions linked to the sorted data region. For example, for all data regions coming from the same data, the data regions may be all bound together so that a sort applied to the scope specified may be propagated to all the other data regions to which it is bound. Sorting may be performed after query execution (i.e., after the data for the report has been extracted from a data source) by selection of a sort control displayed within the report data. Flexible sorting of the data in the report is available. A sort based on a non-visible calculation or element can be performed, the scope of the sort within the report can be specified, group sorting can be performed, a detail sort can be performed in which the detail sort affects only a portion of the report and a sort can be restricted to the contents of an individual group. A sort applied in one report may automatically be applied to other sets of data.

### BRIEF DESCRIPTION OF THE DRAWINGS

In the drawings:

FIG. 1 is a block diagram showing an exemplary computing environment in which aspects of the invention may be implemented;

FIG. 2a is a block diagram showing a report laid out according to data regions in accordance with one embodiment of the present invention;

FIG. 2b is a block diagram showing an example of the report of FIG. 2a;

FIG. 3 is a block diagram showing a report processor and related elements for generating the reports of FIGS. 2a-b in accordance with embodiments of the present invention;

FIGS. 4a-f are block diagrams representing exemplary reports in accordance with one embodiment of the invention;

FIGS. 5a-f are block diagrams representing exemplary reports in accordance with one embodiment of the invention; and

FIG. 6 is a flow diagram of a method for generating reports in accordance with one embodiment of the invention.

### DETAILED DESCRIPTION

Overview

In the present invention, a report is defined declaratively (eliminating the need for custom programming each report) based on data sets, data regions, groups and details. Each data set, data region or group may be further divided into one or more data regions, one or more groups and/or one or more details, recursively, to any level of nesting. All or portions of data from a particular data set may be organized into any of several types of elements including a graph, a table, a chart, a matrix, a header, a footer, and so on. Sorting and/or filtering of the report data is available at a detail, group, data region or data set level after the data extraction phase has been performed. Furthermore, how widespread the effect of the sort or filter is may be specified. For example, all report types, exemplified by, for example, a table, a chart and a matrix coming from the same data, may be all bound together so that one or more of the following are automatically performed: changes (e.g., a change relating to data sorting or filtering) to the table are propagated to the chart and the matrix; changes to the chart are propagated to the table and the matrix, or changes to the matrix are propagated to the table and the chart. Alternatively, changes made to the table, chart or matrix may be all independent, so that changes to one do not affect the others. Alternatively, any combination of the above may be specified. Furthermore, the same is true of any subset of changes. Sorting and filtering may be performed after query execution (i.e., after the data for the report has been extracted from a data source), enabling end-user selection of sorting and filtering options during report viewing by selection of a sort or filter control displayed in the report. Flexible sorting and filtering of the data in the report is available, as described more fully below.

Exemplary Computing Environment

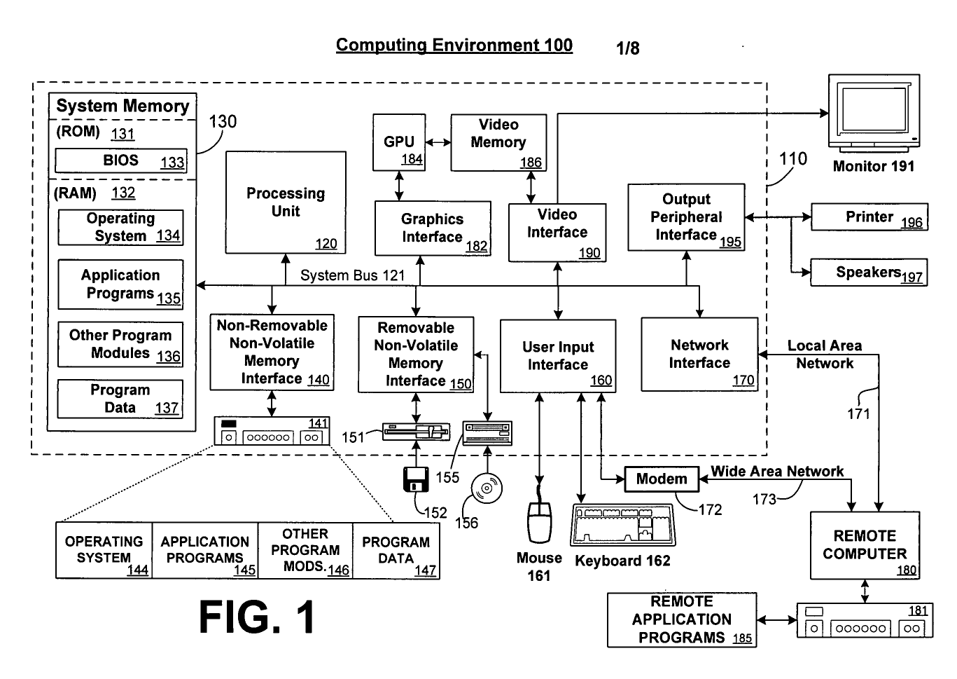

FIG. 1 and the following discussion are intended to provide a brief general description of a suitable computing environment in which the invention may be implemented. It should be understood, however, that handheld, portable, and other computing devices of all kinds are contemplated for use in connection with the present invention. While a general purpose computer is described below, this is but one example, and the present invention requires only a thin client having network server interoperability and interaction. Thus, the present invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer, and/or included within the network browsing software which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

Sorting and Filtering in an Interactive Report

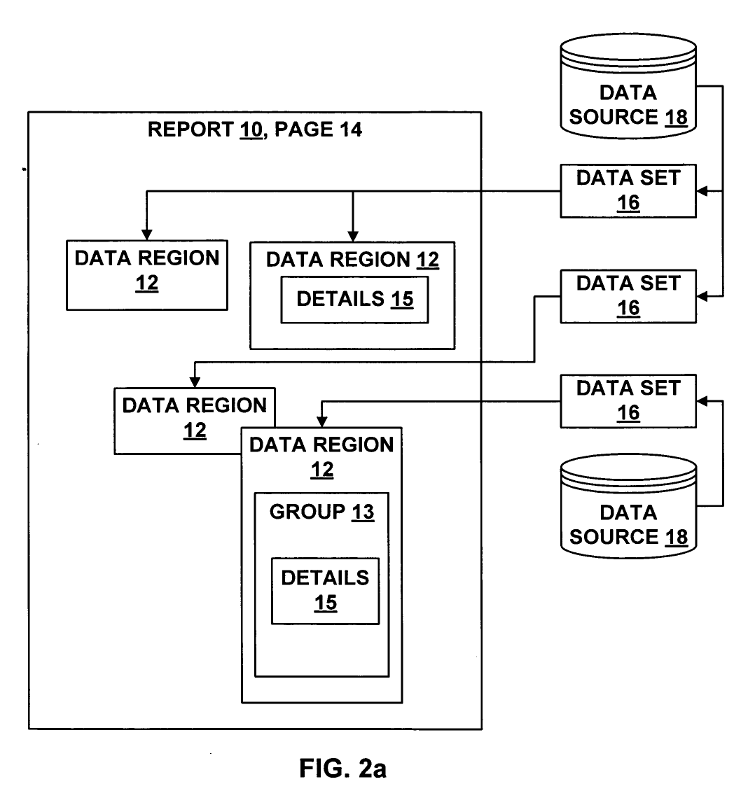

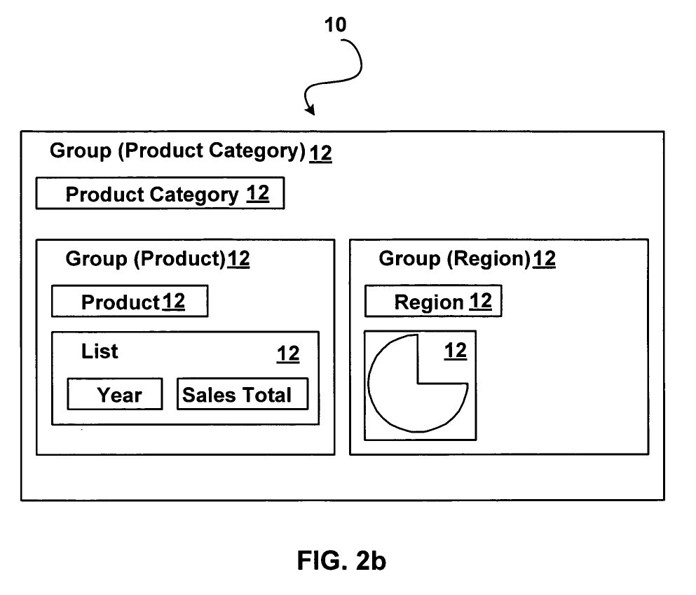

In some embodiments of the present invention, as illustrated by FIG. 2a, a report 10 may be defined to have a plurality of data regions 12 arranged on a page 14. Each data region may derive from a particular data set 16. Each data set 16 may derive from a particular data source 18. A data set 16 may be associated with many data regions 12 and a data source 18 may be associated with many data sets 16. Some data regions 12 in a report 10 may actually have no data from any data set 16 and therefore may be merely regions. Nevertheless, such data-less regions are still characterized as data regions 12. A data region 12 may include one or more groups, as represented in FIG. 2a by group 13 and one or more details as represented by details 15. Similarly, a group 13 may include one or more data regions 12 and details 15. Data regions, groups and details may be nested, data region within group, group(s) within data regions, and so on, recursively, to any desired degree of nesting. Sorting and/or filtering is available at the detail, group, data region and data set level.

Referring now to FIG. 2b, an exemplary report 10 is illustrated. Within exemplary report 10 are a number of data regions 12, each representing, for example, a Product Category group. Thus, the Product Category group data region 12 is repeatable for however many product categories exist. That is, each Product Category group data region 12 may represent a product category and have associated therewith a Product Category data region 12 with the name of the product category. As illustrated in FIG. 2b, the Product data region 12 may be contained within the Product Category group data region 12. Thus, one data region 12 may be located in relation to another data region 12, and one data region 12 may derive from another data region 12 in a parent-child manner.

Within exemplary report 10, for each Product Category group data region 12 there may be one or more data regions 12, each representing a Product group data region 12. Thus, the Product group data region 12 is repeatable for however many products are in the product category. Each Product group data region 12 represents a product and may be associated with a Product data region 12 with the name of the product. Each Product group data region 12 may also have underneath the Product data region 12 a List data region 12 that lists sales totals for the product by year by way of one or more appropriate data regions 12. As seen, the Product data region 12 and List data region 12 are contained within the Product group data region 12, and the data regions 12 of the List data region 12 are contained within such List data region 12.

Within exemplary report 10, for each Product Category group data region 12 there may be one or more data regions 12, each representing a Region group data region 12. Thus, the Region group data region 12 is repeatable for however many regions are in the product category. Each Region group data region 12 may represent a region and have associated therewith a Region data region 12 with the name of the region. Each Region group data region 12 also may have contained within the Region data region 12 a Pie Chart data region 12 that displays a pie chart representative of the region. The Region data region 12 and Pie Chart data region 12 may be contained within the Region group data region 12.

Within the Product Category group data region 12 of report 10, each Product group data region 12 is arranged in exemplary report 10 to appear on the left side and each Region group data region 12 is arranged to appear on the right side. Thus, report 10 as shown in FIG. 2b exhibits data regions extending down, assuming multiple repetitions of the group data definitions, extending across, as represented by the Product group and Region group data regions 12, and extending in a layered fashion.

In some embodiments of the invention, report 10 may present the data filtered or sorted in ascending or descending or unsorted order as specified by an end-user selection in a user interface used for viewing and manipulating the report. In some embodiments of the invention, data may be sorted or filtered on an element, field or column or based on some processing or calculation that is not visible on the report or in the user interface used to view and manipulate the report. Data may be sorted or filtered on a details level, on a group level, on a data region level, on a data set level or on some combination thereof. Moreover, the effect of the sort may extend locally or globally to one or more groups or data regions or to the entire data set. In some embodiments of the invention, the filtered or sorted report is generated from a declarative report definition as described more fully below. In some embodiments of the invention, a declarative report definition is entered by a user via a report-definition user interface. One or more filters or sorts may be applied to the underlying data in the generation of the report.

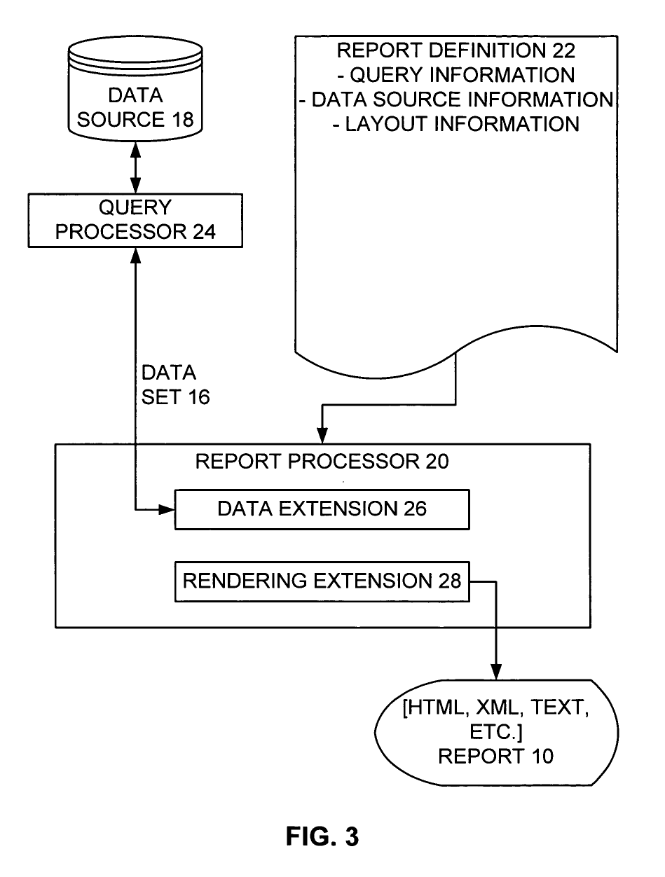

In some embodiments of the present invention, referring now to FIG. 3, a report 10 is generated by a report processor 20 from a report definition 22. As seen, the report definition 22 may include query information on the queries necessary to develop the data sets 16 that are to populate the data regions 12 with data. The report definition 22 may also include data source information for each data source 18 from which the data sets 16 are to be obtained. The queries set forth in the query information may be based on any querying tool without departing from the spirit and scope of the present invention. The data source information in the report definition 22 may include all information necessary to locate and access each necessary data source 18. Such data source information may include a network location of the data source 18, as well as access parameters such as identifications, passwords, access protocols, and so on.

In some embodiments of the present invention, the report processor 20 does not itself access each necessary data source 18 and perform each query, but instead forwards appropriate portions of the query information and data source information to an appropriate query processor 24. Based on such information, the query processor 24 may access the data source 18, perform the query, and forward the query results to the report processor 20 as the data sets 16.

The report definition 22 may also include layout information for the layout of each data region 12 that is to appear in the report. Layout information may include the size of each data region 12, where each data region 12 is to appear on a page 14, how each data region 12 relates to any other data region 12, and whether and if so, how each data region 12 is layered on top of another data region 12. The layout information in the report definition 22 may also include for each defined data region 12 an identification of the data set 16 from which the data for such data region is obtained, and information on how to populate the data region 12 with data set 16.

A sample report definition 22 is set forth in Appendix A, attached. As seen, the report definition 22 is in an XML format, although other formats may also be employed without departing from the spirit and scope of the present invention. An appropriate report definition generating tool (not shown) may be employed to generate the report definition 22. Such generating tool is known or should be apparent to the relevant public based on the present disclosure, and may include appropriate user interface features to assist a user in constructing a report definition 22.

In some embodiments of the invention, the report definition 22 with the query information, the data source information, and the layout information is executed by the report processor 20 to generate the report 10. In doing so, the report processor 20 may employ one or more data extensions 26 to access the data by way of one or more query processors 24. Alternatively, the data extensions 26 may be the query processors 24. Extensibility in the report processor 20 is achieved in that an additional data source 18 can be added at any time by providing an appropriate data extension 26.

In addition, the report processor 20 may employ one or more rendering extensions 28 to render the report 10 in a particular format. For example, if a user specifies that the report 10 is to be rendered in an HTML format, the report processor 20 would select an HTML rendering extension 28 to so render the report 10. Any rendering extension 28 may be employed without departing from the spirit and scope of the present invention. For example, the rendering extension 28 may be an XML, bitmap, printer, TIFF, PostScript, PCL, PDF, or JPEG rendering extension, among others. Extensibility in the report processor 20 is also achieved in that an additional type of rendering can be added at any time by providing an appropriate rendering extension 28.

Suppose that from a collection of data, which may represent an entire data set or may represent a portion of one or more sets of data, a report such as a table, chart, matrix, etc. is generated by a computerized report generator. In accordance with some embodiments of the invention, the report that is generated is defined by a report definition which specifies the source or sources of the data, relationships between data, layout of the data on the report and so on, as described above. The report definition may also define or specify elements relating to the filtering of data in all or portions of the report. In accordance with some embodiments of the invention, in response to selection of a filter control within the report, filtering of the data displayed in the report may be enabled after the data extraction phase of the report generation process. Thus the filtering described herein may be especially useful when the query language of a target data source does not support filtering or provides only limited filtering capabilities. Reports that display different segments of the underlying data in different data regions can be generated using a single query. The query may be associated with one or more filters, each of the one or more filters associated with a particular data region or group. Thus, an end user filtering capability may be provided by providing a filter control attached to a header or data field within the report. Selection of a filter control (by, for example, an end user) while displaying or viewing the report may result in re-display of the report, with the application of the specified filter to the portion of the displayed report data associated with the filter control. A filter may act either locally, on a particular data region, on a particular group or may apply across the entire report. A filter may also apply to multiple sets of data.

In some embodiments of the invention, post-data-extraction filtering of report data is based on parameters. In some embodiments of the invention, these parameters are provided within the report definition or by means of an end-user selection of a filter control in the report or by some combination thereof. In some embodiments of the invention, these parameters include one or more of the following for each filtering process that is to be performed on the extracted report data: filter expression, filter expression scope and filter target. These parameters may be applied at the data set, data region, group or details level. In some embodiments of the invention, an end user filter control may be displayed as part of a textbox in a user interface for viewing and manipulating a report. The end user filter control enables the user to select an operator and filter values for the filter. The filter expression scope and the filter target to apply the filter may also be specified.

A specified filter expression specifies the expression on which the filter is to operate. That is, this parameter defines the expression that is evaluated for each instance within the group or each row of the data set or data region and is compared via an operator to the filter values. Failed comparisons may result in the row or instance being filtered out of the data set, data region or grouping. Operators include but are not limited to: “equal”, “like”, “not equal”, “greater than”, “greater than or equal”, “less than”, “less than or equal”, “top N”, “bottom N”, “top percent”, “bottom percent”, “in”, “between” and so on may be used as a filter operator. A filter value may be specified which provides the value to compare to the filter expression for the filtering operation. A single filter value may be specified in some embodiments of the invention when the operators “equal”, “like”, “not equal”, “greater than”, “greater than or equal”, “less than”, “less than or equal”, “top N”, “bottom N”, “top percent” and “bottom percent” are used. For “between”, two filter values elements may be required. For “in”, the provided filter values may be treated as a set, such that if the filter expression value appears anywhere in the set the instance is not filtered out. It will be appreciated, however, that alternatively, filter operations may operate in the negative, that is, for example, instead of specifying filter values as instances to be kept, a specified filter value may represent instances to be discarded or filtered out.

A filter expression scope in some embodiments of the invention is the name of the scope (e.g., data region or group) in which the filter expression is to evaluated in the report. If no filter expression scope is provided, the filter expression may be evaluated and the filtering operation performed independently in each detail row within the filter target. In some embodiments of the invention, the filter expression scope provided must be equal to or contained within the filter target. In some embodiments the data set to which the filter expression scope applies must be the same as the data set specified for the filter target. In some embodiments of the invention, filtering takes place within the group containing the filter expression scope. For example, in a table with a country group and a city group with an end user filter on country (filter expression scope=country group) and a user filter on city (filter expression scope=city group), the country filter filters country groups within the table and the city filter filters city groups within each country group without impacting totals used in the country group filter calculation.

A filter target in some embodiments of the invention specifies the name of the data region, group or data set to which the filter is to be applied. In some embodiments of the invention, if the filter expression includes an aggregate function, the rows filtered out are determined by the groups defined in the filter expression scope parameter of the aggregate and the filtering is applied to the filter target. For example, if a filter expression contains the value Sum(Fields! Sales, “City”) and the filter target is a State group, when a user chooses “>10000” (operator and filter value) in the “Oregon” instance of the State group, all of the cities that have less than 10000 in total sales will be filtered out of the data used anywhere within that instance of the State group.

In some embodiments of the invention, post-data-extraction sorting of report data is based on parameters. In some embodiments of the invention, these parameters are provided within the report definition or by selection of a sort control in the report or by some combination thereof. In some embodiments of the invention, these parameters include one or more of the following for each sort that is to be performed on the extracted report data: sort expression, sort expression scope and sort target. These parameters may be applied at the data set, data region, group or details level as indicated by, for example, an end-user sort control selection. In some embodiments of the invention, an end user sort control may be displayed as part of a textbox in a user interface for viewing and manipulating a report. The end user sort control enables the user to select a sort direction (ascending, descending or none) for the sort to be applied to the subset of report data associated with the sort control. The sort expression and the scope to apply the sort may also be specified, as well as the sort target.

Sort expression in some embodiments is the expression on which the sort is to be performed: that is, what column, header, field or calculation is to be sorted on. Suppose, for example a data source includes the data:

| Country | Product | Sales |
|---|---|---|
| France | Chair | 100 |
| USA | Table | 50 |
| Canada | Chair | 40 |

In accordance with some embodiments of the invention, the report may be sorted on data elements present in the report (i.e., Country, Product or Sales), or by a data element or calculation not visible in the report. For example, in the above data, possible sort expressions include: country, product, and sales; however, a sort expression may also refer to an element not visible in the report and not visible in the interface for viewing and manipulating the report. For example, suppose a report user would like the data shown above to appear with USA data first followed by all the data from all the other countries in alphabetical order (i.e., first USA data would be listed, then the data for Canada and then the data for France). In some embodiments of the invention, metadata associated with the report definition redefines the “sort on” field or header to another data element which determines sort sequence. For example, metadata may indicate or specify a special value for USA to force rows or records with Country=USA to appear first in the table, even though the special value itself does not appear in the table and does not appear in a user interface for viewing and manipulating the report. (It will be appreciated that similarly, a special value may be assigned to each country instead of only to the USA records or rows to determine a particular sort sequence.)

A sort expression may be specified for each sortable item or collection of items in a report. In some embodiments of the invention, a collection of items may be one of: the entire data set, a data region, as described above, a group or details.

A sort expression scope may also be specified for each sortable item or collection of items to be sorted. In accordance with some embodiments of the invention, the expression scope refers to the scope (e.g., data region or group) in which the sort expression is to be evaluated. In some embodiments, if no sort expression scope is specified, the sort expression is evaluated and the sort is performed independently in each detail row within the set of data in which the sort operates (i.e., within the sort target, described below).

A sort target may also be specified for each sortable item or collection of items to be sorted. In accordance with some embodiments of the invention, the sort target refers to the collection of data sets, data regions or groups to which the sort is to apply.

In accordance with embodiments of the invention, the following sort options are available:

Sort can be performed based on a non-visible calculation

Scope of sort can be specified

Sort on groups is available

Local sort only on details is available

Sort can be restricted to the contents of an individual group

Sort can be Performed Based on a Non-Visible Element or Calculation

Suppose for example, the following data exists in a data source:

| | | | Record |
|---|---|---|---|
| Country | Product | Sales | Number |
| USA | Chair | 100 | 1 |
| USA | Table | 50 | 2 |
| Canada | Chair | 40 | 3 |
| USA | Bench | 10 | 4 |
| Canada | Table | 50 | 5 |
| Canada | Bench | 20 | 6 |
| France | Bench | 40 | 7 |
| France | Chair | 20 | 8 |
| France | Table | 10 | 9 |

As described above, sort expression in some embodiments is the expression on which the sort is to be performed: that is, what is to be sorted on. In accordance with some embodiments of the invention, the report may be sorted on a column (i.e., Country, Product or Sales in the data listed above, which is either a field or a calculation), or by a data element or calculation not visible in the report. For example, in the above data, possible sort expressions include: country, product, and sales. In addition, however, a sort expression may also refer to an element or calculation not visible in the report or in the user interface for viewing and manipulating the report. For example, suppose a report user would like the data shown above to appear with USA data first followed by all the data from all the other countries in alphabetical order (i.e., first USA data would be listed, then the data for Canada and then the data for France). To get this result, a user may specify sort expression=Country_ID, sort expression scope=Group1 (because the user wants to re-arrange groups within the report) and sort target=Table1 (the sort will not affect other data regions in the report that may also be created from the same data) or Dataset1 (the sort will affect other data regions in the report that may also be created from the same data). In some embodiments of the invention, metadata associated with the report definition redefines the “sort on” field or header to another data element or calculation which determines sort sequence. For example, metadata may indicate or specify a special value for the country field (e.g., for USA to force rows or records with Country=USA to appear first in the table), even though the special value itself does not appear in the table or in the user interface used to request the report. (It will be appreciated that similarly, a special value may be assigned to each country instead of only to the USA records or rows to determine a particular sort sequence.)

Scope of Sort can be Specified

For example, suppose the following data:

| Country | Product | Sales |
|---|---|---|
| USA | chair | 40 |
| USA | table | 50 |
| Canada | chair | 10 |
| USA | bench | 20 |

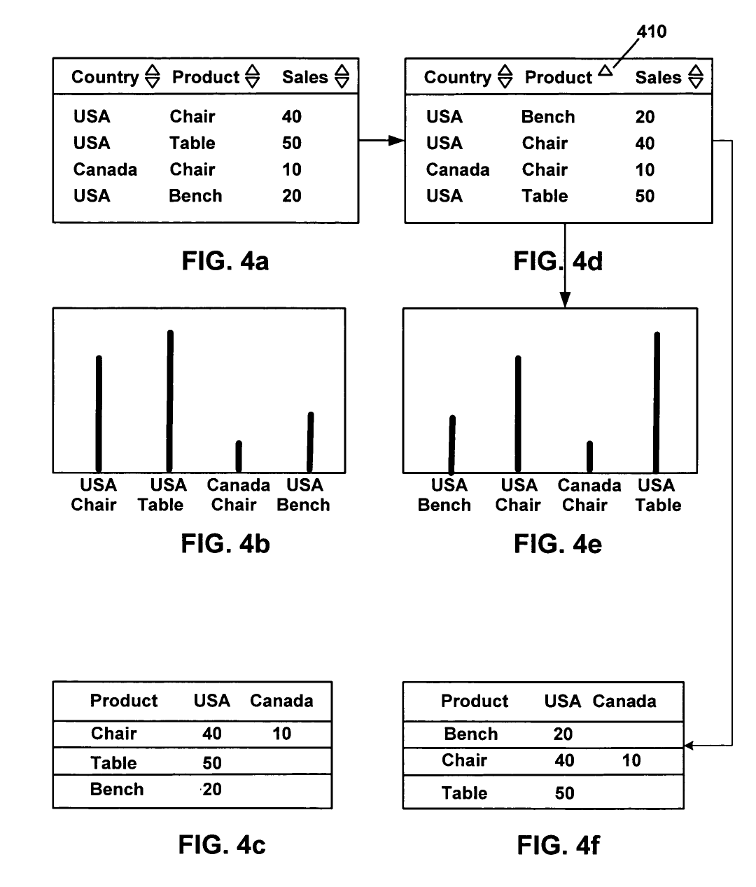

is used to generate the following reports: a table (as illustrated by FIG. 4a) and a chart (as illustrated by FIG. 4b) and a matrix (as illustrated by FIG. 4c). It will be appreciated that tables, charts and matrixes are exemplary data regions only and any types of data region may be generated.

Now suppose that a user would like to have the data of the table of FIG. 4a sorted. In accordance with embodiments of the invention, the data of the table of FIG. 4a may be sorted by fields (country, product or sales). Suppose the user would like the data sorted by product. In accordance with some embodiments of the invention, a user may select a sort icon, such as sort icon 410 of FIG. 4d, indicating that the associated data is to be sorted in ascending order. Alternatively, upon selection of a sort icon, a dialog or a drop down list may be displayed and the user may be prompted for additional information such as: is the information to be presented in ascending order, in descending order or in unsorted order. Suppose, by either method, the user selects “ascending order”. Upon execution of the sort, the order of the table of FIG. 4a is changed to that illustrated in FIG. 4d.

In accordance with some embodiments of the invention, the scope of data affected by the action taken can be selected. In other words, if the action taken is a sort, how widespread the effect of the sort is, is determined by specification of the sort target. For example, suppose the sort is imposed upon the data region (a table) illustrated in FIG. 4a. The effects of the sort performed on the table of FIG. 4a, (which are illustrated in FIG. 4d), may be restricted to the table, or may be propagated to the chart (the effects of which are illustrated in FIG. 4e) or may be propagated to the matrix (the effects of which are illustrated in FIG. 4f), or may be propagated to the chart and the matrix. Furthermore, had the sort been restricted to details, a group or a data region within the table, the effects of the sort could have also been propagated or not propagated to those details, that group or that data region of the chart and matrix. It will be appreciated that although the example illustrates changes to a table that are propagated or not propagated to a chart and/or a matrix, changes made to the matrix or chart may similarly be propagated to the table, and so on. In some embodiments of the invention, control of the scope of the effect of the sort is determined by the sort target.

Sort on Groups is Available

Referring again to the data listed above and reproduced here:

| | | | Record |
|---|---|---|---|
| Country | Product | Sales | Number |
| USA | Chair | 100 | 1 |
| USA | Table | 50 | 2 |
| Canada | Chair | 40 | 3 |
| USA | Bench | 10 | 4 |
| Canada | Table | 50 | 5 |
| Canada | Bench | 20 | 6 |
| France | Bench | 40 | 7 |
| France | Chair | 20 | 8 |
| France | Table | 10 | 9 |

In accordance with some embodiments of the invention, a user may group the data by field. For example, the data above may be usefully sorted into groups by country or by product. Suppose the data is to be grouped by country. The three groups that result may be represented as:

| Group 1: | | | |
|---|---|---|---|
| USA | Chair | 100 | 1 |
| USA | Table | 50 | 2 |
| USA | Bench | 10 | 4 |
| Group 2: | | | |
| Canada | Chair | 40 | 3 |
| Canada | Table | 50 | 5 |
| Canada | Bench | 20 | 6 |
| Group 3: | | | |
| France | Bench | 40 | 7 |
| France | Chair | 20 | 8 |
| France | Table | 10 | 9 |

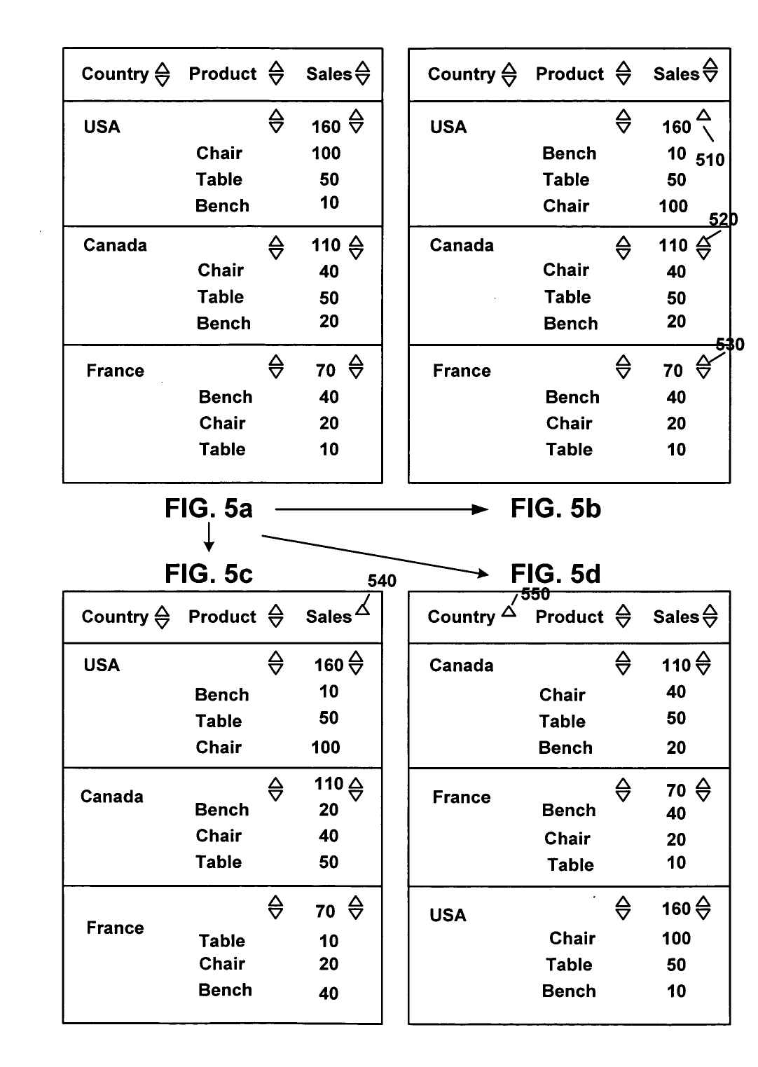

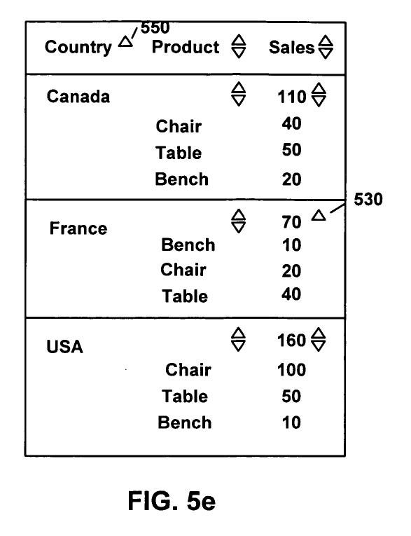

A table generated from this data may appear as illustrated in FIG. 5a. It will be appreciated that the data has been grouped by country. Suppose the user would like to have the groups as a whole sorted, so that Canada data is displayed first, followed by France data and USA data. Selection of icon 550 in some embodiments of the invention may result in the requested sort, as illustrated in the table of FIG. 5d. Alternatively, upon selection of a sort icon, a dialog or a drop down list may be displayed and the user may be prompted for additional information such as: is the information to be presented in ascending order, in descending order or in unsorted order.
Local Sort Only on Details is Available

In accordance with embodiments of the invention, the ability is provided to further sort within groups. For example, suppose the user would like to sort within group 1 by ascending sales. In some embodiments of the invention, sort expression may be set to Sales, sort expression to Details and sort target to Dataset1. An icon 510 (illustrated in FIG. 5b) may be selected (by, for example, clicking on the icon). Alternatively, upon selection of a sort icon, a dialog or a drop down list may be displayed and the user may be prompted for additional information such as: is the information to be presented in ascending order, in descending order or in unsorted order. Upon selection of the appropriate option, the table of FIG. 5b may result. It will be appreciated that by selection of this option, the only group changed by the sort is group 1. That is, the internal sort order of group 2 and group 3 are unchanged. It will be appreciated that selection of icon 520 would have the analogous results only for group 2 data (Canada) and selection of icon 530 would have analogous results only for group 3 data (France), and so on for each group displayed. Now suppose the user would like to have all of the detail data sorted within each group. Selection of icon 540 in some embodiments of the invention, may result in the requested sort, as illustrated in the table of FIG. 5c. It will be appreciated that by selection of this option, all of the groups are changed by the sort, but the data is still displayed within each group and the order of the groups remains unchanged: that is, USA data is still grouped with USA data but is now sorted within the USA, Canada data is still grouped with Canada data but is now sorted within Canada and France data is still grouped with France data but is now sorted within France. It will be appreciated that multiple sorts may be requested, and may be performed in the sequence selected. That is, for example, selection of icons 550 and 530 would result in the table of FIG. 5e in which the data is sorted by country groups and within the group 3 data (France) the details are further sorted internally.

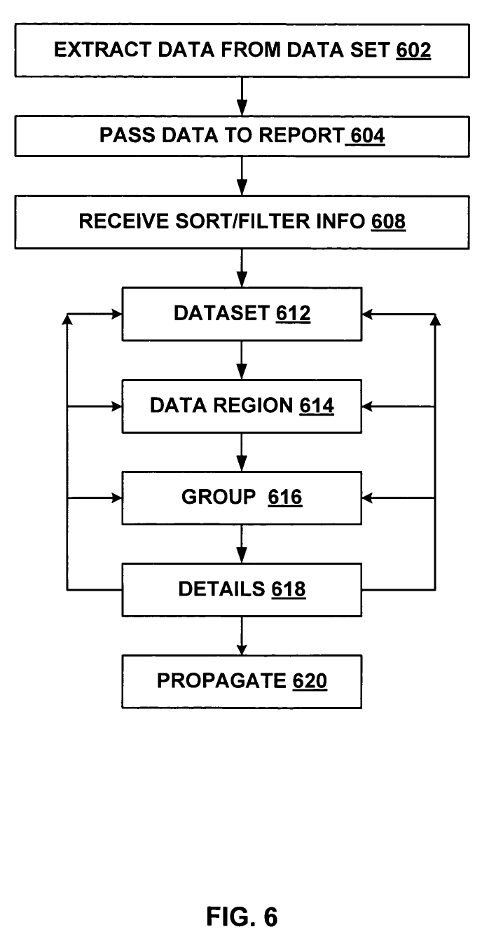

FIG. 6 illustrates an exemplary process for generating a report in accordance with embodiments of the invention. That is, a process employed by the report processor to generate a report based on a report definition and one or more end-user filter or sort control selections within the displayed report, enabling end-user selection of sort and/or filter options after the data extraction phase is shown. In some embodiments of the invention, a user creates the report definition to define the report, specifying the query information, the data source information, the layout information and so on from which the report is to be generated. The same user or another user may submit the created report definition to the report processor. The report processor determines from the data source information in the report definition each data source from which a data set must be obtained to generate the report. In addition, the report processor determines from the query information in the report definition a query that is to be submitted to obtain a data set and the data source to which the query is submitted. At 602 data is extracted from a data source. At 604 any necessary analysis or calculation is performed on the extracted data (e.g., a data set) and the extracted data is passed to the report. The report processor then lays out the report based on the layout information in the report definition.

Based on each data region defined in the report definition the report processor lays out the data region(s) within the report and populates the data region(s) with data from the data set associated with the data region(s) 12. The data is grouped (if the report definition so dictates). If an end user sorting or filtering operation has been requested as indicated by a post data extraction selection of a sort or filter control, (608), and further calculations are required, this is performed. Processing continues at the data set level (612), and within the data set for each data region within the data set at the data region level (614), for each group within each data region at the group level (616) and for each group at the details level (618) as required by the structure of the report as specified in the report definition. That is, for any particular report, during the first iteration of the process, for example, no group level processing may be defined for a particular region, in which case, no group level processing at step 616 would be performed during that iteration, etc. When all the processing has been completed, the report is displayed or otherwise provided. At 620, the results of the sorting or filtering as just described is applied to other scopes (datasets/data regions/groups) as indicated by the sort target or filter target.

For example, suppose a report requesting Country, Product and Sales information from a particular data source is to be run. Suppose further that in addition to Country, Product and Sales information, a total sales for the Country is desired. Let us assume that the sort expression selected for the data region is Sum(Sales), the sort expression scope selected is Group1 and the sort target is Dataset1. In some embodiments of the invention, a query (e.g., “SELECT Country, Product, Sales from SALES”) may be issued on the data source. Suppose at 602 the data is extracted from the data source. Suppose that the extracted data is the following:

Data Collection 1:

| | | |
|---|---|---|
| USA | Chair | 100 |
| USA | Table | 50 |
| Canada | Chair | 40 |
| USA | Bench | 10 |
| Canada | Table | 50 |
| Canada | Bench | 20 |

Data collection 1 at 604 may be handed to the data region (e.g., a table) and the data may be grouped (sorted on Country, and placed into groups at 616 for example). Grouping creates an intermediate data collection:

Data Collection 2:

| | | |
|---|---|---|
| USA | Chair | 100 |
| USA | Table | 50 |
| USA | Bench | 10 |
| Canada | Chair | 40 |
| Canada | Table | 50 |
| Canada | Bench | 20 |

Because a sort (the sum of sales for the country) is defined to be calculated at the group level, (608) Data Collection 2 is passed to a calculate phase. The sum of all sales for the group (country) is calculated and added to Data Collection 2 to generate Data Collection 3 as follows:

Data Collection 3:

| | | | |
|---|---|---|---|
| USA | Chair | 100 | 160 |
| USA | Table | 50 | |
| USA | Bench | 10 | |
| Canada | Chair | 40 | 110 |
| Canada | Table | 50 | |
| Canada | Bench | 20 | |

Alternatively, Data Collection 3 may include only the sum of sales for each country, as follows:

Data Collection: 3

160
110

The results indicated in Data Collection 3, or alternatively collectively in Data Collection 2 and Data Collection 3 are then applied to the original data collection, Data Collection 1, to generate Data Collection 4 as follows:

Data Collection 4:

| | | | |
|---|---|---|---|
| USA | Chair | 100 | 160 |
| USA | Table | 50 | 160 |
| Canada | Chair | 40 | 110 |
| USA | Bench | 10 | 160 |
| Canada | Table | 50 | 110 |
| Canada | Bench | 20 | 110 |

Data Collection 4 is passed to the sort, generating Data Collection 5, as follows:

Data Collection 5:

| | | | |
|---|---|---|---|
| USA | Chair | 100 | 160 |
| USA | Table | 50 | 160 |
| USA | Bench | 10 | 160 |
| Canada | Chair | 40 | 110 |
| Canada | Table | 50 | 110 |
| Canada | Bench | 20 | 110 |

Because the sort target is Dataset 1, Data Collection 5 is passed back up to the data region level where the process is continued for each group (616) in each region (614). The results of the sorting are applied as indicated by the sort target.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

Appendix A
Sample Report Definition 22

<?xml version=“1.0” encoding=“utf-8”?>
<Report
xmlns=“http://schemas.microsoft.com/sqlserver/reporting/2003/10/reportdefinit
ion”
xmlns:rd=“http://schemas.microsoft.com/SQLServer/reporting/reportdesigner”>

<RightMargin>1in</RightMargin>
<Body>

<ReportItems>

<Table Name=“table1”>

<Height>0.75in</Height>
<Style />
<Header>

<TableRows>

<TableRow>

<Height>0.25in</Height>
<TableCells>

<TableCell>

<ReportItems>

<Textbox Name=“textbox1”>

<UserSort>

<SortExpression>=Fields!Country.Value</SortExpression>
<SortExpressionScope>table1_Group1</SortExpressionScope>

<SortTarget>table1</SortTarget>

</UserSort>
<Style>

<PaddingLeft>2pt</PaddingLeft>
<PaddingBottom>2pt</PaddingBottom>
<PaddingTop>2pt</PaddingTop>
<PaddingRight>2pt</PaddingRight>

</Style>
<ZIndex>8</ZIndex>
<CanGrow>true</CanGrow>
<Value>Country</Value>

</Textbox>

</ReportItems>

</TableCell>
<TableCell>

<ReportItems>

<Textbox Name=“textbox2”>

<UserSort>

<SortExpression>=Fields!ProductID.Value</SortExpression>

<SortTarget>table1</SortTarget>

</UserSort>
<Style>

<PaddingLeft>2pt</PaddingLeft>
<PaddingBottom>2pt</PaddingBottom>
<PaddingTop>2pt</PaddingTop>
<PaddingRight>2pt</PaddingRight>

</Style>
<ZIndex>7</ZIndex>
<CanGrow>true</CanGrow>
<Value>Product</Value>

</Textbox>

</ReportItems>

</TableCell>
<TableCell>

<ReportItems>

<Textbox Name=“textbox3”>

<UserSort>

<SortExpression>=Sum(Fields!Sales.Value)</SortExpression>
<SortExpressionScope>table1_Group1</SortExpressionScope>

<SortTarget>DataSet1</SortTarget>

</UserSort>
<Style>

<PaddingLeft>2pt</PaddingLeft>
<TextAlign>Right</TextAlign>
<PaddingBottom>2pt</PaddingBottom>
<PaddingTop>2pt</PaddingTop>
<PaddingRight>2pt</PaddingRight>

</Style>
<ZIndex>6</ZIndex>
<rd:DefaultName>textbox3</rd:DefaultName>
<CanGrow>true</CanGrow>
<Value>Sales</Value>

</Textbox>

</ReportItems>

</TableCell>

</TableCells>

</TableRow>

</TableRows>

</Header>
<Details>

<TableRows>

<TableRow>

<Height>0.25in</Height>
<TableCells>

<TableCell>

<ReportItems>

<Textbox Name=“textbox4”>

<Style>

<PaddingLeft>2pt</PaddingLeft>
<PaddingBottom>2pt</PaddingBottom>
<PaddingTop>2pt</PaddingTop>
<PaddingRight>2pt</PaddingRight>

</Style>
<ZIndex>2</ZIndex>
<rd:DefaultName>textbox4</rd:DefaultName>
<CanGrow>true</CanGrow>
<Value />

</Textbox>

</ReportItems>

</TableCell>
<TableCell>

<ReportItems>

<Textbox Name=“Product”>

<Style>

<PaddingLeft>2pt</PaddingLeft>
<PaddingBottom>2pt</PaddingBottom>
<PaddingTop>2pt</PaddingTop>
<PaddingRight>2pt</PaddingRight>

</Style>
<ZIndex>1</ZIndex>
<CanGrow>true</CanGrow>
<Value>=Fields!ProductName.Value</Value>

</Textbox>

<ReportItems>

</TableCell>
<TableCell>

<ReportItems>

<Textbox Name=“Sales”>

<Style>

<PaddingLeft>2pt</PaddingLeft>
<TextAlign>Right</TextAlign>
<PaddingBottom>2pt</PaddingBottom>
<PaddingTop>2pt</PaddingTop>
<PaddingRight>2pt</PaddingRight>

</Style>
<rd:DefaultName>Sales</rd:DefaultName>
<CanGrow>true</CanGrow>
<Value>=Fields!Sales.Value</Value>

</Textbox>

</ReportItems>

</TableCell>

</TableCells>

</TableRow>

</TableRows>

</Details>
<DataSetName>DataSet1</DataSetName>
<Top>0.125in</Top>
<Width>4.875in</Width>
<TableGroups>

<TableGroup>

<Header>

<TableRows>

<TableRow>

<Height>0.25in</Height>
<TableCells>

<TableCell>

<ReportItems>

<Textbox Name=“Country”>

<Style>

<PaddingLeft>2pt</PaddingLeft>
<PaddingBottom>2pt</PaddingBottom>
<PaddingTop>2pt</PaddingTop>
<PaddingRight>2pt</PaddingRight>

</Style>
<ZIndex>5</ZIndex>
<rd:DefaultName>Country</rd:DefaultName>
<CanGrow>true</CanGrow>
<Value>=Fields!Country.Value</Value>

</Textbox>

</ReportItems>

</TableCell>
<TableCell>

<ReportItems>

<Textbox Name=“textbox5”>

<Style>

<PaddingLeft>2pt</PaddingLeft>
<PaddingBottom>2pt</PaddingBottom>
<PaddingTop>2pt</PaddingTop>
<PaddingRight>2pt</PaddingRight>

</Style>
<ZIndex>4</ZIndex>
<rd:DefaultName>textbox5</rd:DefaultName>
<CanGrow>true</CanGrow>
<Value />

</Textbox>

</ReportItems>

</TableCell>
<TableCell>

<ReportItems>

<Textbox Name=“textbox6”>

<Style>

<PaddingLeft>2pt</PaddingLeft>
<PaddingBottom>2pt</PaddingBottom>
<PaddingTop>2pt</PaddingTop>
<PaddingRight>2pt</PaddingRight>

</Style>
<ZIndex>3</ZIndex>
<rd:DefaultName>textbox6</rd:DefaultName>
<CanGrow>true</CanGrow>
<Value />

</Textbox>

</ReportItems>

</TableCell>

</TableCells>

</TableRow>

</TableRows>

</Header>
<Grouping Name=“table1_Group1”>

<GroupExpressions>

<GroupExpression>=Fields!Country.Value</GroupExpression>

</GroupExpressions>

</Grouping>

</TableGroup>

</TableGroups>
<TableColumns>

<TableColumn>

<Width>1.5in</Width>

</TableColumn>
<TableColumn>

<Width>1.875in</Width>

</TableColumn>
<TableColumn>

<Width>1.5in</Width>

</TableColumn>

</TableColumns>

</Table>

</ReportItems>
<Style />
<Height>1in</Height>

</Body>
<TopMargin>1in</TopMargin>
<DataSources>

<DataSource Name=“Northwind”>

<rd:DataSourceID>7b1e0bdc-5fd5-4ded-8ecc-559104460302</rd:DataSourceID>
<DataSourceReference>Northwind</DataSourceReference>

</DataSource>

</DataSources>
<Width>5in</Width>
<DataSets>

<DataSet Name=“DataSet1”>

<Fields>

<Field Name=“ProductID”>

<DataField>ProductID</DataField>
<rd:TypeName>System.Int32</rd:TypeName>

</Field>
<Field Name=“ProductName”>

<DataField>ProductName</DataField>
<rd:TypeName>System.String</rd:TypeName>

</Field>
<Field Name=“Country“>

<DataField>Country</DataField>
<rd:TypeName>System.String</rd:TypeName>

</Field>
<Field Name=“Sales”>

<DataField>Sales</DataField>
<rd:TypeName>System.Decimal</rd:TypeName>

</Field>

</Fields>
<Query>

| <DataSourceName>Northwind</DataSourceName> | |
|---|---|
| <CommandText>SELECT | Products.ProductID, Products.ProductName, |

Customers.Country, SUM([Order Details].UnitPrice * [Order Details].Quantity)
AS Sales

| | |
|---|---|
| FROM | [Order Details] INNER JOIN |

Orders ON [Order Details].OrderID = Orders.OrderID

INNER JOIN

Customers ON Orders.CustomerID = Customers.CustomerID

INNER JOIN

Products ON [Order Details].ProductID =

Products.ProductID
GROUP BY Products.ProductName, Products.ProductID,
Customers.Country</CommandText>

</Query>

</DataSet>

</DataSets>
<LeftMargin>1in</LeftMargin>
<rd:SnapToGrid>true</rd:SnapToGrid>
<rd:DrawGrid>true</rd:DrawGrid>
<rd:ReportID>95f70422-c781-4e1d-8d17-30948ab5f4f1</rd:ReportID>
<BottomMargin>1in</BottomMargin>
<Language>en-US</Language>

</Report>

What is claimed:

1. A system for providing an end user sort capability in a computerized report generator comprising:
a report processor that enables specification of a sort expression for determining a sort to be performed on extracted report data during report processing, a sort expression scope for determining a scope of data on which the sort acts and a sort target for determining a plurality of sets of data to which the sort is propagated.

2. The system of claim 1, wherein the report processor produces a report in which the sort is performed on a datum or calculation not visible in the report and not visible in a user interface for viewing and manipulating the report.

3. The system of claim 1, wherein the report processor produces a report in which details of groups within the report are sorted or a report in which the sort is restricted to contents of an individual group in the report.

4. The system of claim 1, wherein the report processor produces a report in which groups are sorted.

5. The system of claim 1, wherein the report processor enables an end user selection of sort order after a data extraction phase of report generation, comprising one of ascending, descending or unsorted.

6. The system of claim 1, wherein the report processor generates a report based on a parameterized report definition.

7. The system of claim 2, wherein the user interface displays a user sort control enabling a sort to be applied to portions of the report comprising at least one of a data set, a data region, a group or detail rows after a data extraction phase of report generation.

8. A method of enabling an end user to sort report data based on an end user sort specification comprising:
receiving the end user sort specification after a data extraction phase of report generation; and
performing the specified sort based on the end user sort specification and a report definition comprising a sort expression, a sort expression scope and a sort target.

9. The method of claim 8, further comprising:
receiving the sort expression comprising a field or calculation on which the report data is to be sorted;
receiving the sort expression scope specifying a portion of the report data within a generated report to which a sort specified by the sort expression will apply; and
receiving the sort target specifying at least one additional set of data to which the received sort expression acting within the received sort expression scope will automatically be applied.

10. The method of claim 8, further comprising generating a report as specified by the sort expression, the sort expression scope and the sort target.

11. The method of claim 8, wherein the sort expression is defined in the report definition to comprise a calculation or sort expression not present in a report generated from the report definition or in an interface for specifying the end user sort specification.

12. The method of claim 8, wherein the sort expression scope comprises one of a data set, a data region, a group or detail rows.

13. The method of claim 8, wherein the specified sort is propagated to at least one of a plurality of other sets of data.

14. A computer-readable medium comprising computer-executable instructions for performing the following:
structuring extracted report data into levels based on a report definition, the levels comprising at least one of a data set, one or more data regions, one or more groups, or one or more detail rows;
receiving:
a filter expression, specifying a field or calculation on which to filter the extracted report data;
a filter expression scope specifying a portion of the extracted report data within a report generated from the extracted report data to which a filtering operation as specified by the filter expression will apply; and
a filter target specifying at least one additional data region to which the received filter expression acting within the received filter expression scope will automatically be applied.

15. The computer-readable medium of claim 14, comprising further instructions for:
enabling an end user to specify a filter operator and a filter value to be applied after a data extraction phase of report generation by selecting a filter control attached to a column or data field in a report generated from the extracted report data based on the report definition.

16. The computer-readable medium of claim 15, comprising further instructions for:
applying the end user specified filter locally to a single subset of the extracted report data, wherein the single subset comprises a data region or a group or a data set.

17. The computer-readable medium of claim 15, comprising further instructions for:
applying the end user specified filter globally to all occurrences of groups in the extracted report data of the report.

18. The computer-readable medium of claim 17, comprising further instructions for:
applying a filter as defined by the filter operator, filter value, filter expression, filter expression scope and filter target to a plurality of sets of data based on the extracted report data.

19. The computer-readable medium of claim 18, comprising further instructions for:
applying the filter to each row of data in the data set or to each row of data in the data region or to each instance of a group in the data set or to a single group in the data set.

20. The computer-readable medium of claim 19, comprising further instruction to:
enabling multiple filters to be applied to the extracted report data, wherein the multiple filters are applied in sequence.
